(19) United States
(12) Patent Application Publication
(10) Pub. No.: US 2018/0130247 A1
(43) Pub. Date: May 10, 2018

(54) PRODUCING VISUAL ART WITH A MUSICAL INSTRUMENT

(71) Applicant: Zvi Yaniv, Austin, TX (US)

(72) Inventor: Zvi Yaniv, Austin, TX (US)

(21) Appl. No.: 15/808,366

(22) Filed: Nov. 9, 2017

Related U.S. Application Data
(60) Provisional application No. 62/420,287, filed on Nov. 10, 2016.

(51) Int. Cl. G06T 15/02; G06T 19/20; G06F 3/02; G10H 1/00; G10H 1/32

(52) U.S. Cl. CPC G06T 15/02; G06T 19/20; G06F 3/02; G10H 2220/221; G10H 1/32; G06T 2219/2024; G06T 2219/2012; G10H 1/0008

(57) ABSTRACT

Producing a visual work of art includes receiving software commands produced in response to plurality of singular manual inputs by a user to a digital input device, and in response to the received software commands, producing visual elements by an output device, wherein the software commands are preprogrammed to produce different visual elements as a function of one or more particular singular manual inputs by the user to the digital input device. The digital input device may be a digital musical instrument. The software commands can be preprogrammed to produce visual elements that mimic a style of a particular artist.

This application claims priority to U.S. provisional patent application No. 62/420,287, which is hereby incorporated by reference herein.

### TECHNICAL FIELD

The present invention relates in general to a computerized system for creating a work of art.

### BACKGROUND INFORMATION

Using a conventional computer system for creating original works of art can be difficult to a majority of users because utilization of typical input devices, such as a QWERTY keyboard and mouse, can be awkward for a user to create various image elements to be displayed on a display screen or other visual device. The pressing of alphanumeric keys on a keyboard and the point and click actions of a mouse typically only utilize the more analytical left hemisphere of the human brain. In contrast, with musical instruments, a person learns to intuitively manipulate their inputs (e.g., piano keyboard, guitar strings, etc.) in a more creative manner that marries the innate capabilities of both the left and right hemispheres of the brain, similar to how an artist manipulates the strokes of a paint brush.

However, there is no input device similar to a musical instrument that one can utilize to create a painting by playing the instrument such that instead of music being output (for hearing pleasure), one can create a painting or other work of art (for example, for viewing pleasure).

### BRIEF DESCRIPTION OF THE DRAWINGS

FIG. 1 illustrates a process flow diagram configured in accordance with embodiments of the present invention.

FIG. 2 illustrates an exemplary embodiment of how a digital painting can be created utilizing embodiments of the present invention.

FIGS. 3-6 illustrate examples of how various visual elements of a digital painting can be created utilizing embodiments of the present invention.

FIG. 7 illustrates a data processing system configured in accordance with embodiments of the present invention.

### DETAILED DESCRIPTION

In accordance with embodiments of the present invention, as referred to herein, a visual element may be represented as any output produced by an output device that can be visually seen (e.g., as produced by a display device, a paper printer, a three-dimensional (“3D”) printer, etc.) A visual work of art may be produced as a combination of one or more of such visual elements.

Almost any musical instrument can be utilized in a digitized mode (for example, a guitar, a wind instrument, a piano, etc.). Embodiments of the present invention utilize a digital musical instrument (or a digitized output of an analog musical instrument), such as a digital piano keyboard, for creating a painting or other work of art for display, such as on a display device, or printed for subsequent display. For example, when a user presses a key on a digital piano keyboard, a command that would normally produce a particular sound additionally creates on a display screen a particular visual element of a painting. This operation can be extended to some or all of the keys of the piano keyboard such that a “painter player” can play the instrument and create a painting on the display screen. This painting can then be erased or can be changed until the desired image that the painter has in mind is created on the display screen. Then, the creation can be electronically saved, transmitted, and/or printed in full color. A similar process can be performed with other digital musical instruments.

Though embodiments of the present invention are described herein utilizing a piano keyboard for creating images (e.g., paintings) on a display screen, any musical instrument may be utilized in a similar manner, or any other device by which a user can make a plurality of singular manual inputs to the device, which can then be translated into commands to produce visual elements in accordance with embodiments of the present invention. Moreover, embodiments of the present invention may encompass any type of device that can receive manual inputs from a user whereby such manual inputs are then electronically translated into software instructions delivered to an output device configured to produce one or more visual elements as a function of the received software instructions. Examples of such devices include any type of keyboard whereby the user manually presses various keys whether any music (or any type of sound) is audibly produced, manual inputs made by a user on a touch display screen, manual inputs made by a user utilizing a device that senses the manual inputs even when the user does not actually touch the device, user-generated manual inputs via a holographic imaging device, a device implementing positional sensors (for example, a Wii® device or equivalent apparatus, personal computing device, etc.).

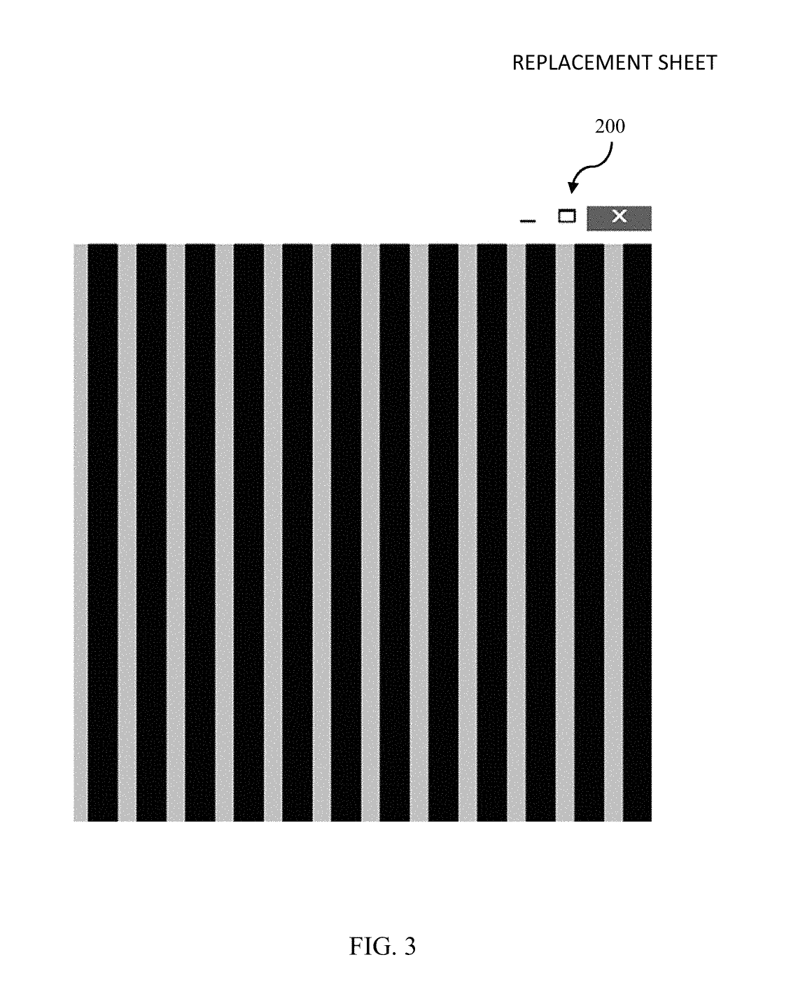

In accordance with certain embodiments of the present invention, a visual work of art can be produced by user-generated manual inputs to any of the foregoing devices whereby such user-generated manual inputs are translated by computer program code that instructs an output device (e.g., a display device) to produce visual elements that result in the visual work of art, wherein the computer program code is configured so that the produced visual elements mimic a style of a particular artist (e.g., painter). Examples of such a particular style of painting attributed to the artist Yaacov Agam are utilized to describe exemplary embodiments of the present invention (e.g., see FIGS. 3-6). However, embodiments of the present invention may be configured to implement other painting styles, such as, but not limited to, those by the following artists: Picasso, Victor Vassarely, Gene Dubuffet, Joseph Albers, Olle Baertling, etc.

Exemplary embodiments of the present invention are described herein utilizing MIDI (“musical instrument digital interface”) code for interfacing a musical instrument to a computer system, which has been programmed to interpret a user's manipulation of inputs to the musical instrument and convert these manual inputs into visual elements of a work of art (e.g., painting) created by the user. Taking for example a piano keyboard, conventional implementations of MIDI code (also referred to herein as MIDI commands, MIDI messages, or MIDI instructions) attach an individual programmed code to each piano key in which a software driver assigns a musical function to the respective key. In accordance with embodiments of the present invention, the MIDI codes are modified to interface with a software driver that assigns to each MIDI command a drawing function, which may then be displayed on a display screen or other visual devices, or output as visual elements by an appropriate output device.

MIDI is a technical standard that describes a protocol, digital interface, and connectors to allow a wide variety of electronic musical instruments, computer, and other related devices to connect and communicate with one another. MIDI technology was standardized in 1983 by a panel of music industry representatives, and is maintained by the MIDI Manufacturers Association (“MMA”). The MIDI standard allows different instruments to “communicate” with each other and with computers. As an example, when a note is played on a MIDI instrument, it generates a digital signal that can be used to trigger a note on another instrument. As such, it is possible to change key, instrumentation, or tempo of a MIDI arrangement, and to reorder its individual sections. The data composed via the sequenced MIDI recordings can be saved as a standard MIDI file (“SMF”), digitally distributed, and reproduced by any computer or electronic instrument that also adheres to the same MIDI and SMF standards. A MIDI musical instrument digital interface allows a variety of musical instruments to interact with a computer system in a digital environment for recording or performance. When utilized for creating music, MIDI carries event commands that specify notation, pitch and velocity, control signals for parameters such as volume, vibrato, audio panning, cues, and clock signals that set and synchronize tempo between multiple devices. These commands are sent via a MIDI cable to other devices where they control sound generation and other features. A simple example of a MIDI setup is the use of a MIDI controller such as an electronic musical keyboard to trigger sounds created by a sound module (e.g., speaker). This MIDI data can also be recorded into a hardware or software device called a sequencer, which can be used to edit the data and play it back at a later time. A MIDI command, or message, is an instruction that controls some aspect of the receiving device. MIDI commands are made up of eight-byte words that are transmitted serially, wherein the first bit of each word identifies whether the word is a status byte or a data byte, and is followed by seven bytes of information. Thus, a MIDI file is not a recording of actual audio. Rather, it is a set of instructions, and can use a thousand times less disk space than equivalent recorded audio. Moreover, MIDI software allows recorded MIDI to be manipulated using standard computer editing features, such as cut, copy and paste, and drag and drop. Further, MIDI has been adopted as a control protocol in a number of non-musical applications. For example, MIDI Show Control uses MIDI commands to direct stage lighting systems and to trigger cued events in theatrical productions. Thus, MIDI can control any device that can read and process a MIDI command. The receiving device or object may utilize a general MIDI processor wherein program changes trigger a function on that device rather than notes from the MIDI instrument.

Embodiments of the present invention may utilize a digital musical instrument, such as a digital piano keyboard, coupled to a MIDI controller implemented with a data processing (computer) system. However, in accordance with embodiments of the present invention, the MIDI code is modified so that the modified MIDI commands instruct the video controller of the data processing system to create visual elements on a display device. Such MIDI code can be modified in any desired manner by the programmer to create various combinations of visual elements on a display device, which can be specifically customized to produce visual elements according to a particular painting style, such as those of particular artists and painters. With such a customization, a user of embodiments of the present invention can create their own digital painting utilizing the particular painting style of an artist of their choice.

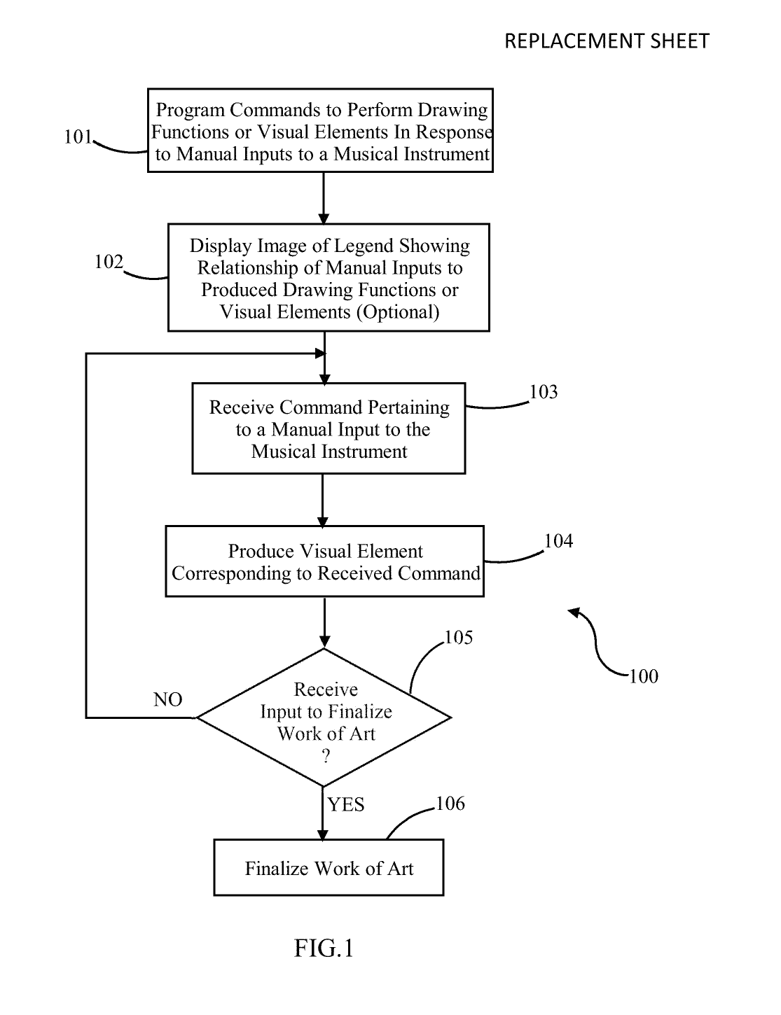

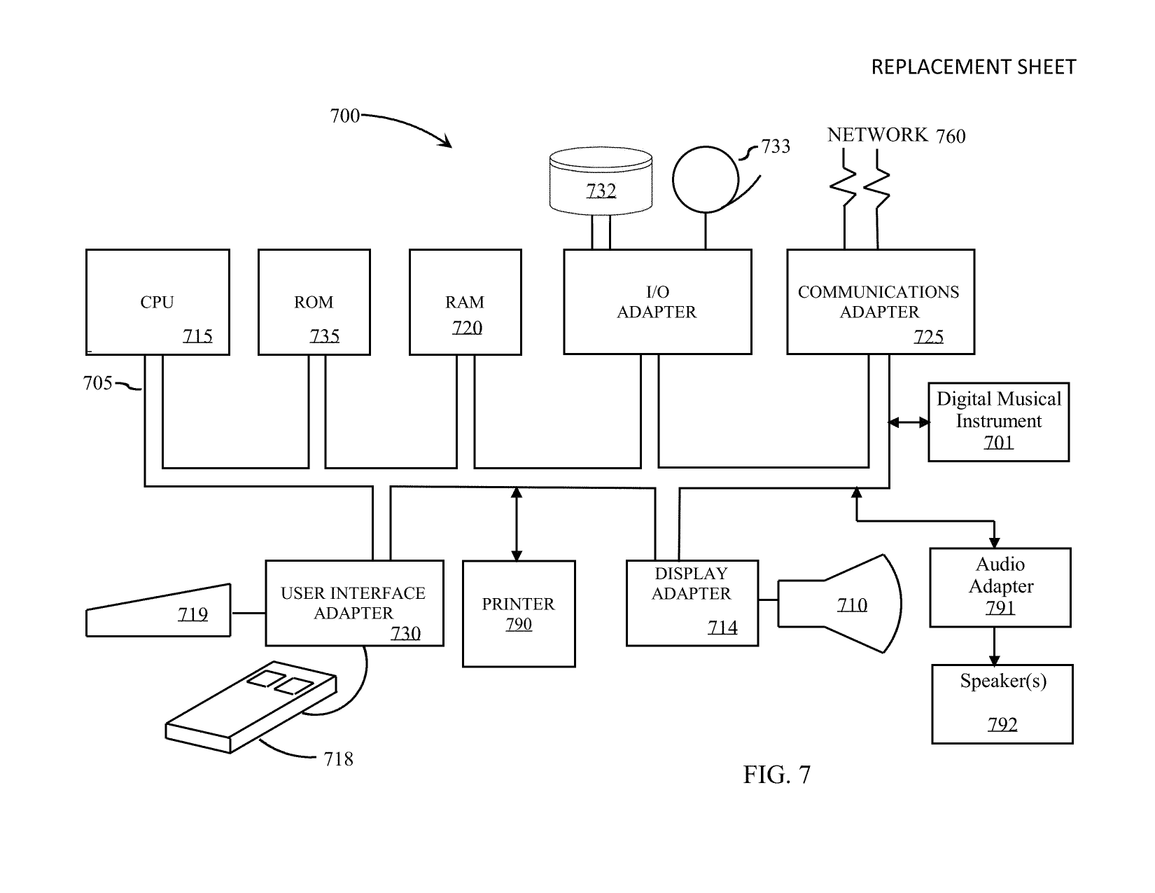

Referring to FIG. 1, there is illustrated a flowchart diagram of a process 100 configured in accordance with embodiments of the present invention. The process 100, which may be implemented in part or in whole within the data processing system 700 described herein with respect to FIG. 7, provides for a programming and utilization of hardware and software configured to enable utilization of musical instrumentation to create a work of art, which may be displayed or presented for viewing by some form of output device (e.g., on a display device (e.g., the display device 710 of FIG. 7)). However, as previously noted herein, in accordance with embodiments of the present invention, the process 100 may be configured to function with any type of device that can receive manual inputs from a user whereby such manual inputs are then electronically translated into software instructions delivered to an output device configured to produce one or more visual elements as a function of the received software instructions.

In the process block 101, manual inputs by a user(s) (e.g., manual pressing of piano keys) to one or more musical instruments (e.g., the digital musical instrument 701 of FIG. 7) have been programmed to enable a user to perform various drawing functions (e.g., produce various visual elements) in response to the manual inputs, which may be programmed in accordance with (i.e., mimic) a particular predetermined artistic style (e.g., a particular painting style, such as the brush strokes of a particular painter). For example, the system (e.g., the data processing system 700) may be configured to utilize MIDI code as a control protocol whereby a MIDI command is modified to interpret (e.g., translate) a piano keyboard key press by a user (or any other manual input to a digital music instrument) to display a specified visual element on the display device. In accordance with a non-limiting embodiment of the present invention, the system 700 may be implemented with a MIDI processor, or the processor in the system 700 (e.g., the CPU 715 of FIG. 7) may be configured to process MIDI commands similar to a MIDI processor. As such, one or more MIDI commands may be assigned to each of one or more piano keys, which are programmed to produce (in response to the user-generated manual inputs to the one or more piano keys) a specified visual element on the display device. Correspondingly, the MIDI commands may be preprogrammed so that specified key presses command the video controller (see the display adapter 714 of FIG. 7) of the data processing system 700 to display a particular color, type of paint brush stroke, etc., including producing combinations of colors, painting strokes, etc. in response to the pressing of combinations of piano keys and/or how quickly and/or how forcefully such piano keys are manually pressed by the user.

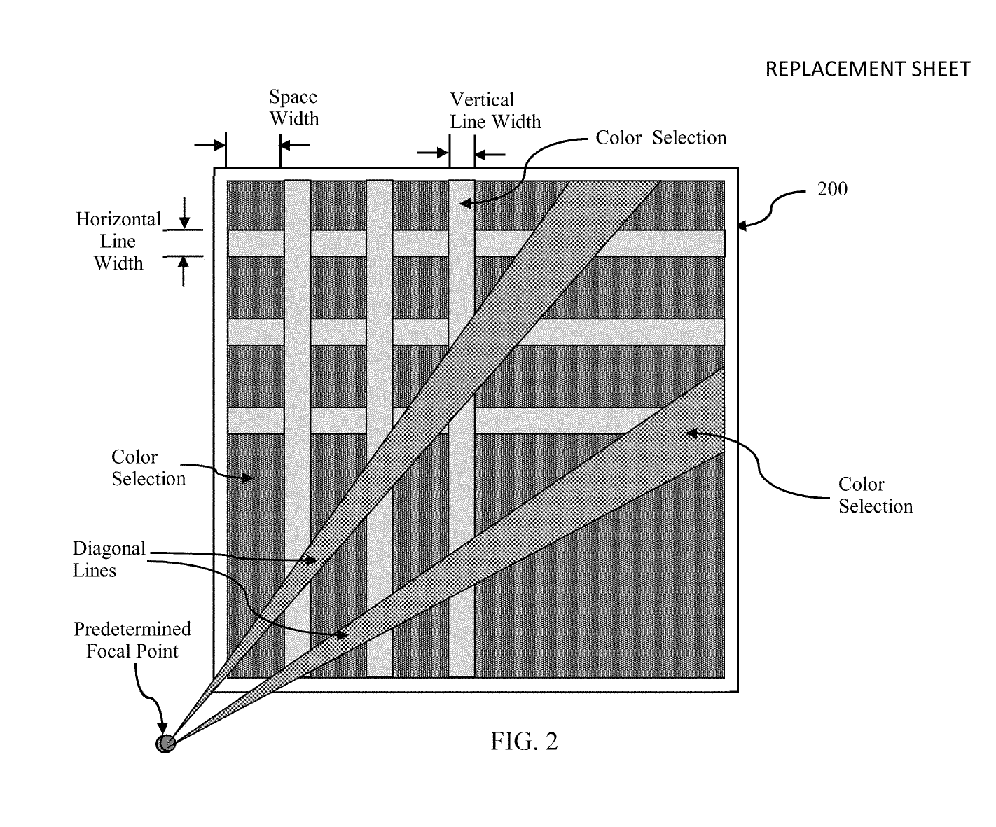

For example, in accordance with a non-limiting exemplary embodiment of the present invention, one or more of the white keys of a digital piano may be associated by the MIDI code to create on a display screen particular visual elements, while one or more of the black keys may be associated by the MIDI code to create variations of (or modify) such visual elements created by the white keys. Thus, a user may press specified combinations of white and black keys to create one or more visual elements where each one is a different variation of the same kind of visual element. This is further described herein with respect to FIG. 2.

As previously discussed, MIDI commands, or messages, are programmable instructions. Thus, the MIDI commands can be preprogrammed in the process block 101 so that a MIDI processor converts manipulated inputs (from a user of a digital musical instrument (e.g., a digital piano keyboard) implemented with a MIDI controller) to video processing commands for producing a predetermined (programmed) visual element on a display device.

Though FIGS. 3-6 will be described herein to provide examples of how such MIDI commands can be programmed to produce the displayed visual elements, one of ordinary skill in the art would be able to program MIDI commands and assign them to various musical instrument inputs, or combinations of such inputs, so that desired visual elements are output onto a display device (or any other desired output device), similar to how MIDI commands are programmed to produce a desired musical note to be output by a sound speaker.

Furthermore, as previously noted, the MIDI commands may be programmed so that the piano key presses produce visual elements that mimic the painting (artistic) style of a particular artist. As such, in accordance with embodiments of the present invention, the system could be preprogrammed with a plurality of such painting styles, each of which can then be selected by the user before commencing their work of art. Thus, if the user desires to create a digital painting in accordance with a particular painting style (e.g., pertaining to a particular artist), the system can permit the user to select such a style as they begin to use the system, and may even be configured to permit the user to change such a painting style at any moment while they are creating their digital painting (and thus, combine the styles of various artists (painters)).

The process block 102 may be optionally implemented within the system 700 to display an image of a legend on the display device (such as in a corner or border of the display screen) indicating the drawing functions, or visual elements, programmed for each of the piano keys. Such a legend may additionally include an image of the keyboard with the drawing functions, or visual elements, assigned to each of the keys. Alternatively, such a legend may be provided in a printed booklet, or available to the user by accessing it from an accompanying CDROM or by a hyperlink directed to a web page.

Once the user decides to begin to use the system to create their digital painting, in the process block 103, the system will receive a user-generated manual input to the musical instrument (e.g., a piano key press input, or combination of piano key press inputs) from the user. As previously described, each of these musical instrument inputs triggers the sending of associated programmed (e.g., MIDI) commands to the video controller, which may be configured to implement a MIDI processor or controller programmed to translate received MIDI commands to the display of desired visual elements. In the process block 104, the video controller will then draw an image (e.g., one or more visual elements) on the display device corresponding to the key press input(s) to the digital musical instrument.

In the process block 105, a determination is made by the system whether some sort of input has been received from the user that they desire to finalize their digital painting. If not, then the system loops back through the process blocks 103-105 until the user has decided to finalize their digital painting. It can be readily appreciated by one of ordinary skill in the art that the process blocks 103 and/or 104 may include other types of digital image creation and editing functionalities, such as cut, copy, paste, delete, etc., which may result from user input(s) to the digital musical instrument or some other input device (e.g., the mouse 718, the keyboard 719, or a touch screen 710). Moreover, in accordance with embodiments of the present invention, the process blocks 103 and/or 104 may be configured to enable a user to modify, or even delete, a sequence of created visual elements (e.g., modify or delete all horizontal lines, including changing whether certain lines are hidden underneath other lines or not).

In the process block 106, the produced images (i.e., combination of created visual elements) on the display device (e.g., the display device 710) may be finalized by the user, such as for storing within a memory device (e.g., the hard disk 732 of FIG. 7) of the data processing system 700, electronically transmitting the finalized digital painting (e.g., via an email message) over a network (e.g., the network 760 of FIG. 7) coupled to the system 700, or for printing by a printer (e.g., the printer 790 of FIG. 7) coupled to the system 700.

FIG. 2 illustrates a schematic diagram illustrating a non-limiting example of how the system 700 may be programmed to produce and display visual elements on a display screen 200 (e.g., the display screen 200 may be implemented as part of the display device 710 of FIG. 7) in accordance with a specified (preprogrammed) painting style. The exemplary painting style depicted in FIG. 2 involves the creation of various vertical, horizontal, and diagonal colored lines in a specified manner, as desired by the user. For example, the system 700 can be programmed so that the inputs to a digital musical instrument (e.g., pressing of a particular piano key or keys) produces a horizontal line having a specified color and a specified line width at a specified location on the display screen 200. Another musical instrument input or inputs (e.g., piano key press or combination of piano key presses) produces a vertical line having a specified color and specified line width at a specified location on the display screen 200. Likewise, yet still another specified musical instrument input or inputs (e.g., piano key press, or combination of key presses) produces a diagonal line of a specified color and specified line width at a specified location on the display screen 200. The system may be further programmed so that the user can press one or more musical instrument input or inputs (e.g., piano key press(es)) to determine a specified focal point for one or more created diagonal lines, including having such a specified focal point positioned outside of the effective display screen viewing area.

In a non-limiting exemplary embodiment of the present invention, the system 700 may be configured so that pressing of a particular white key of a digital piano creates a specified horizontal line, while the pressing of various one or more black keys in combination with the white key can be performed by the user to vary the color, width, etc. of the horizontal line. Likewise, a different white key press can create a vertical line, which can be modified (color, width, etc.) by the aforementioned black keys. Additionally, certain key presses can be performed so that a particular line is displayed over or under a previously created visual element (e.g., a colored line). As can be seen, the system 700 can be configured so that various key presses and/or combinations of key presses produce a wide variety of such visual elements, and in accordance with a particular preprogrammed painting style.

FIGS. 3-6 illustrate a non-limiting example of how a digital painting can be created by a user with a particular painting style in accordance with embodiments of the present invention.

This non-limiting example shows how the software commands (e.g., modified MIDI commands) can be preprogrammed (e.g., see the process block 101) to produce visual elements that mimic the painting style of the artist Yaacov Agam. As a result, this particular example demonstrates how embodiments of the present invention can enable a user to utilize manual inputs to a device (e.g., a digital musical instrument) to create their own painting that mimics the painting style of the artist Yaacov Agam.

For example, referring to FIG. 3, the user may begin by pressing one or more piano keys, or combinations of piano keys, (see the process block 103) to create a plurality of vertical lines on the display screen 200 (see the process block 104), wherein each of the vertical lines has a particular color, or colors, a particular line width, or line widths, and a particular width, or widths, between each of the vertical lines. The user may also press one or more keys to select a background color.

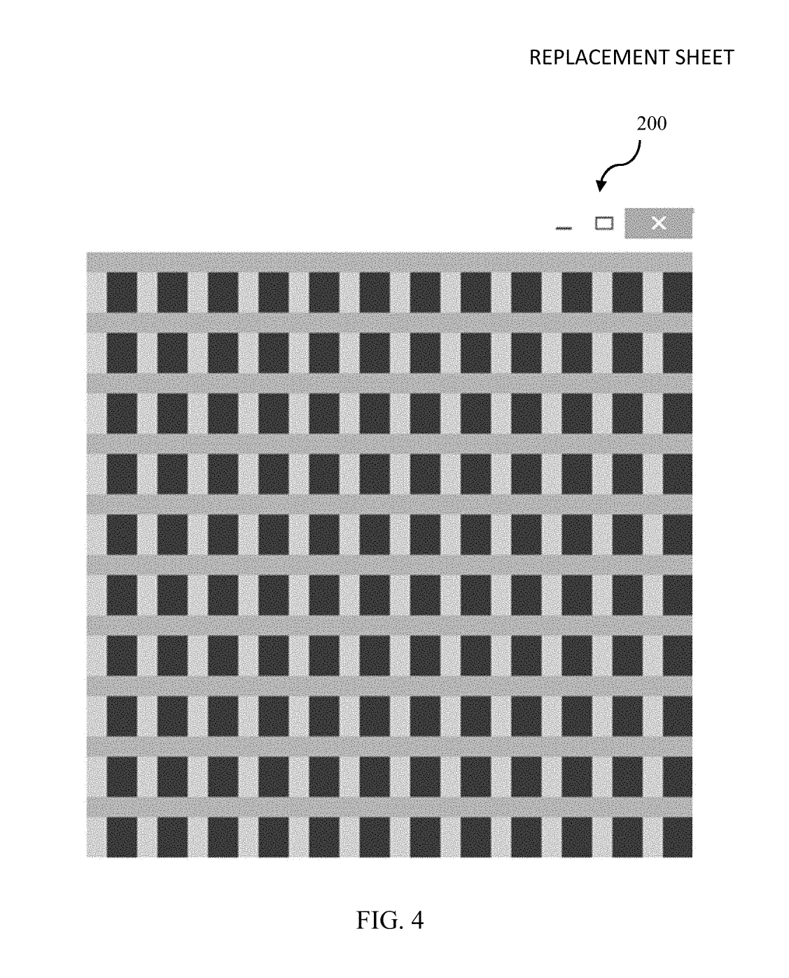

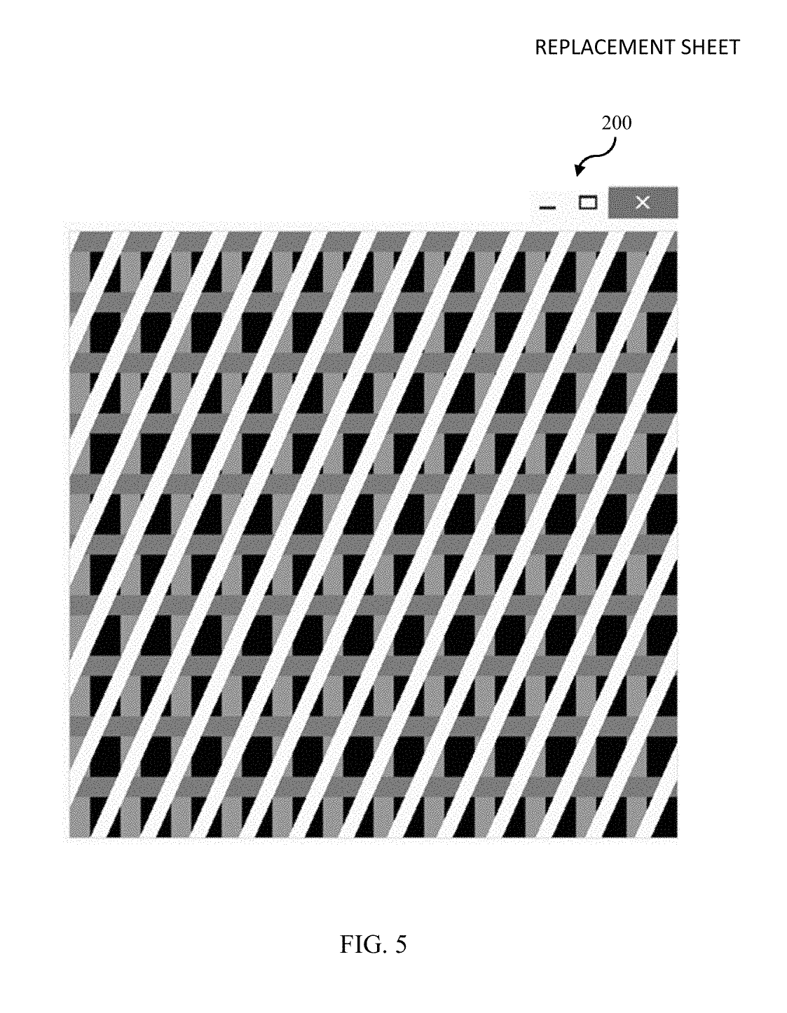

In a next iteration, the user can then press one or more keys to create one or more horizontal lines, such as illustrated in FIG. 4. And, if desired, the user can then press one or more keys to create one or more diagonal lines in a similar fashion, such as illustrated in FIG. 5, and so on. Such a process can be continued as desired by the user (see the process blocks 103 and 104).

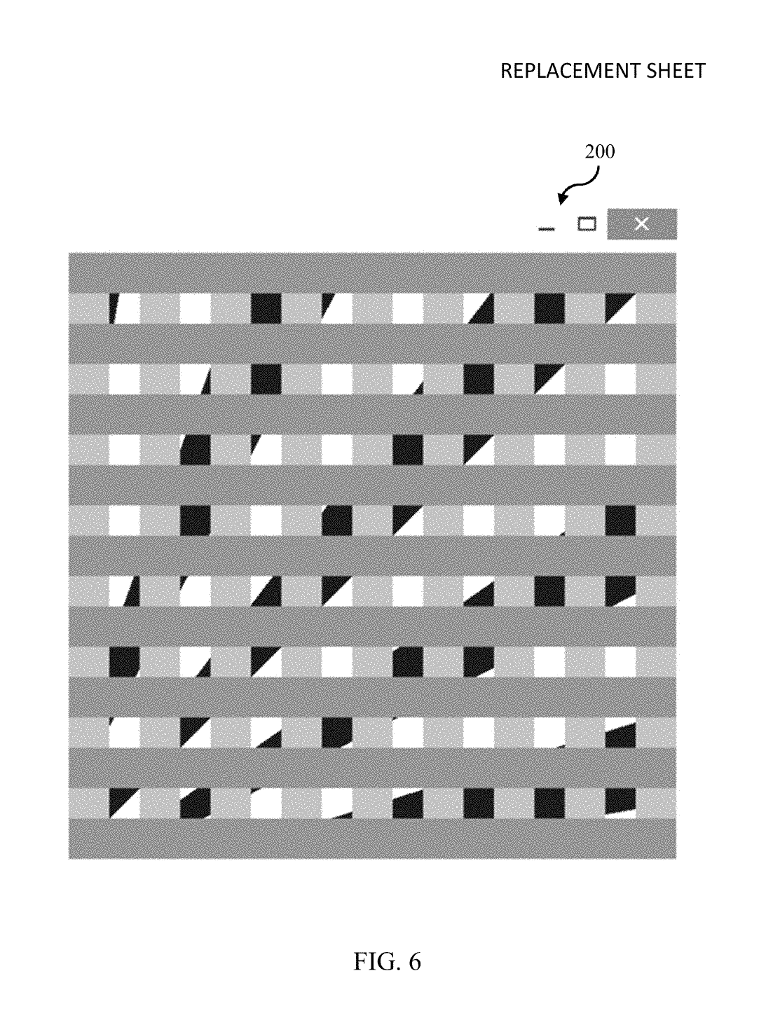

FIG. 6 illustrates an iteration of the exemplary created digital painting by a user on the display screen 200, which shows examples of how the user can manipulate their digital painting using the piano key presses so that certain horizontal, vertical, and/or diagonal lines have different colors, different widths, different angles, and relative positioning with respect to each other.

It should be noted that embodiments of the present invention are not limited to producing works of art on a display device. Alternatively, other output devices may be utilized by embodiments of the present invention whereby a user manipulates a digital musical instrument (or an analog musical instrument coupled to a system for digitizing inputs to the musical instrument) to create works of art embodied as a series of video images, a 3D object (e.g., a sculpture), and the like. For example, instead of a display device, a 3D printer may be programmed to produce a 3D object created by a user. Alternatively, the system 700 may be configured to permit the user to create a 3D sculpture displayed on the display device (e.g., the display device 710), which may then be output to a 3D printer (e.g., the printer 790) for a physical 3D printing of the sculpture.

As will be appreciated by one skilled in the art, aspects of the present invention may be embodied as a system, method, and/or program product. Accordingly, aspects of the present invention may take the form of an entirely hardware embodiment, an entirely software embodiment (including firmware, resident software, micro-code, etc.), or embodiments combining software and hardware aspects that may all generally be referred to herein as a “circuit,” “circuitry,” “module,” or “system.” Furthermore, aspects of the present invention may take the form of a computer program product embodied in a non-transitory manner on one or more computer readable storage medium(s) having computer readable program code embodied thereon. (However, any combination of one or more computer readable medium(s) may be utilized. The computer readable medium may be a computer readable signal medium or a computer readable storage medium.)

A computer readable storage medium may be, for example, but not limited to, an electronic, magnetic, optical, electromagnetic, infrared, biologic, atomic, or semiconductor system, apparatus, controller, or device, or any suitable combination of the foregoing. More specific examples (a non-exhaustive list) of the computer readable storage medium may include the following: an electrical connection having one or more wires, a portable computer diskette, a hard disk 732, a random access memory (“RAM”) 720, a read-only memory (“ROM”) 735, an erasable programmable read-only memory (“EPROM or Flash memory), an optical fiber, a portable compact disc read-only memory (“CD-ROM”), an optical storage device, a magnetic storage device (e.g., tape drive 733), or any suitable combination of the foregoing. In the context of this disclosure, a computer readable storage medium may be any tangible medium that can contain or store a program for use by or in connection with an instruction execution system, apparatus, controller, or device. Software program code (e.g., MIDI code) embodied on a computer readable signal medium may be transmitted using any appropriate medium, including but not limited to wireless, wire line, optical fiber cable, RF, etc., or any suitable combination of the foregoing.

The flowchart and block diagram in the figures illustrate architecture, functionality, and operation of possible implementations of systems, methods, and program products according to various embodiments of the present invention. In this regard, each block in the flowchart or block diagram may represent a module, segment, or portion of code, which comprises one or more executable program instructions for implementing the specified logical function(s). It should also be noted that, in some implementations, the functions noted in the blocks may occur out of the order noted in the figures. For example, two blocks shown in succession may, in fact, be executed substantially concurrently, or the blocks may sometimes be executed in the reverse order, depending upon the functionality involved.

Modules implemented in software for execution by various types of processors (e.g., the CPU 715) may, for instance, include one or more physical or logical blocks of computer instructions, which may, for instance, be organized as an object, procedure, instruction, command, or function. Nevertheless, the executables of an identified module need not be physically located together, but may include disparate instructions stored in different locations which, when joined logically together, include the module and achieve the stated purpose for the module. Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The data may provide electronic signals on a system (e.g., the system 700) or a network (e.g., the network 760).

These program instructions may be provided to a processor and/or controller (e.g., the CPU 715) of a general purpose computer (e.g., the system 700), special purpose computer, or other programmable data processing apparatus (e.g., controller) to produce a machine, such that the instructions, which execute via the processor of the computer or other programmable data processing apparatus, create means for implementing the functions/acts specified in the flowchart and/or block diagram block or blocks.

It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions. For example, a module may be implemented as a hardware circuit (e.g., a MIDI processor), custom VLSI circuits or gate arrays, or off-the-shelf semiconductors such as logic chips, transistors, controllers, or other discrete components. A module may also be implemented in programmable hardware devices such as field programmable gate arrays, programmable array logic, programmable logic devices, or the like.

Computer program code, i.e., instructions, for carrying out operations for aspects of the present invention may be written in any combination of one or more programming languages (e.g., MIDI code), an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network (e.g., the network 760), including a local area network (“LAN”) or a wide area network (“WAN”), or the connection may be made to an external computer (for example, through the Internet using an Internet Service Provider).

These program instructions may also be stored in a computer readable storage medium that can direct a computer, other programmable data processing apparatus, controller, or other devices to function in a particular manner, such that the instructions stored in the computer readable medium produce an article of manufacture including instructions which implement the function/act specified in the flowchart and/or block diagram block or blocks.

The program instructions may also be loaded onto a computer, other programmable data processing apparatus, controller, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Reference is made herein to “configuring” a device, or a device (e.g., circuitry) configured to perform a particular function. It should be understood that this may include selecting predefined logic blocks and logically associating them, such that they provide particular logic functions, which includes monitoring or control functions. It may also include programming computer software-based logic of a device, wiring discrete hardware components, or a combination of any or all of the foregoing.

Reference throughout this specification to “embodiment,” “one embodiment,” “embodiments,” or similar language means that a particular feature, structure, or characteristic described in connection with the embodiments is included in at least one embodiment of the present invention. Thus, appearances of the phrases “in one embodiment,” “in an embodiment,” “embodiments,” and similar language throughout this specification may, but do not necessarily, all refer to the same embodiment. Furthermore, the described features, structures, aspects, and/or characteristics of the invention may be combined in any suitable manner in one or more embodiments. Correspondingly, even if features may be initially claimed as acting in certain combinations, one or more features from a claimed combination can in some cases be excised from the combination, and the claimed combination can be directed to a sub-combination or variation of a sub-combination.

In the descriptions herein, numerous specific details are provided, such as examples of programming (e.g., MIDI code), software modules, user selections, network transactions, database queries, database structures, hardware modules, hardware circuits, hardware chips, controllers, etc., to provide a thorough understanding of embodiments of the invention. One skilled in the relevant art will recognize, however, that the invention may be practiced without one or more of the specific details, or with other methods, components, materials, and so forth (e.g., some other programmable code equivalent to MIDI, which can be utilized to translate inputs to a musical instrument into various software driven drawing functions). In other instances, well-known structures, materials, or operations may be not shown or described in detail to avoid obscuring aspects of the invention.

With reference now to FIG. 7, a block diagram illustrating a data processing (computer) system 700 is depicted in which aspects of embodiments of the invention may be implemented. The data processing system 700 may employ a peripheral component interconnect (“PCI”) local bus architecture. Although the depicted example employs a PCI bus, other bus architectures such as Accelerated Graphics Port (“AGP”) and Industry Standard Architecture (“ISA”) may be used, among others. Processor (“CPU”) 715, volatile memory (“RAM”) 720, and non-volatile memory (“ROM”) 735 may be connected to a local bus (“PCI”) 705 through a PCI Bridge (not shown). The PCI Bridge also may include an integrated memory controller and cache memory for processor 715. Additional connections to the local bus 705 may be made through direct component interconnection or through add-in boards. In the depicted example, a network communication adapter 725, small computer system interface (“SCSI”) host bus adapter (not shown), and expansion bus interface (not shown) may be connected to the local bus 705 by direct component connection. An audio adapter 791, graphics adapter (not shown), and display adapter 714 may be connected to the local bus 705 by add-in boards inserted into expansion slots. The audio adapter 791 may be coupled to one or more speakers 792 for playing musical notes created by the musical instrument (e.g., the digital musical instrument 701). The display adapter may include a video controller, which may be configured, in accordance with embodiments of the present invention, to implement a MIDI processor or controller programmed to translate received MIDI commands to the display of desired visual elements.

An expansion bus interface (not shown) may provide a connection for a use interface adapter 730, modem (not shown), and additional memory (not shown). A SCSI host bus adapter (not shown) may provide a connection for a hard disk drive 732, tape drive 733, and CD-ROM drive (not shown).

An operating system may be run on the processor 715 and used to coordinate and provide control of various components within the data processing system 700 in FIG. 7. The operating system may be a commercially available operating system. An object-oriented programming system, such as Java, may run in conjunction with the operating system and provide calls to the operating system from Java programs or programs executing on the system 700. Instructions for the operating system, the object-oriented operating system, and programs may be located on non-volatile memory storage devices, such as the ROM 735 or hard disk drive 732, and may be loaded into volatile memory 720 for execution by the processor 715.

Those of ordinary skill in the art will appreciate that the hardware in FIG. 7 may vary depending on the implementation. Other internal hardware or peripheral devices, such as a flash ROM (or equivalent nonvolatile memory) or optical disk drives and the like, may be used in addition to or in place of the hardware depicted in FIG. 7. Also, various processes of the present invention may be applied to a multiprocessor computer system.

As another example, the system 700 may be a stand-alone system configured to be bootable without relying on some type of network communication interface, whether or not the system 700 includes some type of network communication interface. As a further example, the system 700 may be an embedded controller, which is configured with ROM and/or flash ROM providing non-volatile memory storing operating system files or user-generated data.

The depicted example in FIG. 7 and above-described examples are not meant to imply architectural limitations. Further, a computer program form of the present invention may reside on any computer readable storage medium (i.e., floppy disk, compact disk, hard disk, tape, ROM, RAM, etc.) used by a computer system. (The terms “data processing system,” “computer,” “system,” and “computer system” may be used interchangeably herein.)

Benefits, advantages, and solutions to problems have been described above with regard to specific embodiments. However, the benefits, advantages, solutions to problems, and any element(s) that may cause any benefit, advantage, or solution to occur or become more pronounced may be not to be construed as critical, required, or essential features or elements of any or all the claims.

No element described herein is required for the practice of the invention unless expressly described as essential or critical.

Herein, the term “or” may be intended to be inclusive, wherein “A or B” includes A or B and also includes both A and B.

The terminology used herein is for the purpose of describing particular embodiments only and is not intended to be limiting of the invention. As used herein, the singular forms “a,” “an,” and “the” may be intended to include the plural forms as well, unless the context clearly indicates otherwise.

The corresponding structures, materials, acts, and equivalents of all means or step plus function elements in the claims below may be intended to include any structure, material, or act for performing the function in combination with other claimed elements as specifically claimed.

The description of the present invention (and the exemplary embodiments of FIGS. 2-6) has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as may be suited to the particular use contemplated.

What is claimed is:

1. A method for producing a visual work of art, comprising:
receiving software commands produced in response to a plurality of singular manual inputs by a user to a digital input device; and
in response to the received software commands, producing visual elements by an output device, wherein the software commands are preprogrammed to produce different visual elements as a function of one or more of the plurality of singular manual inputs by the user to the digital input device.

2. The method as recited in claim 1, wherein the software commands are preprogrammed to produce visual elements that mimic a style of a particular artist.

3. The method as recited in claim 2, wherein one or more of the software commands are preprogrammed to produce visual elements that mimic one or more particular painting strokes of a particular painter.

4. The method as recited in claim 1, wherein the visual work of art is a painting and the output device is a computer display device, wherein at least one of the software commands is preprogrammed to produce one or more visual elements that mimic a particular style of painting stroke producing at least a portion of the painting.

5. The method as recited in claim 4, wherein the digital input device is a musical instrument.

6. The method as recited in claim 4, wherein the software commands are modified musical instrument digital interface (“MIDI”) commands configured to translate the manual inputs by the user to the musical instrument into instructions to a video controller for displaying the visual elements on the computer display device.

7. The method as recited in claim 4, wherein the musical instrument is a digital musical instrument.

8. The method as recited in claim 2, wherein the output device is a three-dimensional (“3D”) printer.

9. A system for producing a visual work of art, comprising:
a musical instrument;
electronic circuitry configured to digitize user-generated manual inputs to the musical instrument into software commands representing preprogrammed visual elements for producing the visual work of art; and
circuitry configured to output the visual elements on an output device as a function of the software commands.

10. The system as recited in claim 9, wherein the software commands are preprogrammed so that the visual elements are produced in a manner that mimics a style of a particular artist.

11. The system as recited in claim 9, wherein the visual work of art is a painting and the output device is a computer display device, wherein one or more of the software commands are preprogrammed so that the visual elements are produced in a manner that mimics one or more particular painting strokes of a particular painter.

12. The system as recited in claim 11, wherein the software commands are modified MIDI commands configured to translate the user-generated manual inputs to the musical instrument into instructions to a video controller for displaying the visual elements on the computer display device.

13. The system as recited in claim 9, wherein the output device is a 3D printer.

14. A computer program product comprising a computer readable storage medium having computer readable program code embodied therewith, the computer readable program code comprising:
computer readable program code configured to receive a first command representing a first manual input by a user to a musical instrument; and
computer readable program code configured to produce, in response to the received first command, a first visual element by an output device.

15. The computer program product as recited in claim 14, further comprising:
computer readable program code configured to receive a second command representing a second manual input by the user to the musical instrument; and
computer readable program code configured to produce, in response to the received second command, a second visual element by the output device,
wherein the second manual input by the user to the musical instrument is performed differently than the first manual input by the user to the musical instrument resulting in the second command having a different structure than the first command, and
wherein the second visual element is visually different than the first visual element as a function of the different structures of the first and second commands.

16. The computer program product as recited in claim 15, wherein the first and second commands are programmed so that the first and second visual elements are produced in a manner that mimics a style of a particular artist.

17. The computer program product as recited in claim 16, wherein the first and second visual elements form at least a portion of a painting displayed on a computer display device, wherein the first and second visual elements represent painting strokes producing at least a portion of the painting.

18. The computer program product as recited in claim 15, wherein the first and second commands are modified MIDI commands.

19. The computer program product as recited in claim 15, wherein the first and second commands are modified MIDI commands configured to translate the first and second manual inputs to the musical instrument into first and second instructions to a video controller for displaying the first and second visual elements on the output device.

20. The computer program product as recited in claim 14, further comprising:
computer readable program code configured to receive a second command representing a second manual input by the user to the musical instrument; and
computer readable program code configured to produce, in response to the received second command, a modification to the first visual element by the output device,
wherein the second manual input by the user to the musical instrument is performed differently than the first manual input by the user to the musical instrument resulting in the second command having a different structure than the first command
